(19) United States
(12) Patent Application Publication
(10) Pub. No.: US 2016/0239891 A1
(43) Pub. Date: Aug. 18, 2016

(54) GENETIC-BASED E-COMMERCE SYSTEMS AND METHODS

(71) Applicant: JOSÉ VIRGILIO BRAGHETTO NETO, Ribeirao Preto - SP (BR)

(72) Inventor: JOSÉ VIRGILIO BRAGHETTO NETO, Ribeirao Preto - SP (BR)

(21) Appl. No.: 15/140,303

(22) Filed: Apr. 27, 2016

Related U.S. Application Data
(63) Continuation-in-part of application No. 14/422,123, filed on Feb. 17, 2015, now abandoned.
(60) Provisional application No. 61/684,632, filed on Aug. 17, 2012.

(51) Int. Cl. G06Q 30/06; G06Q 30/02

(52) U.S. Cl. CPC G06Q 30/0613; G06Q 30/0633; G06Q 30/0201

(57) ABSTRACT

Genetic-based e-commerce systems and methods are provided. A genetic-based e-commerce system includes a genetic information database that is electronically accessible over at least one network system and stores genetic information associated with at least one user of the system. A public or private database is included and stores associations between genetic information and products or services. A genetic-based e-commerce application is included and facilitates purchase by the user of products or services based on the user's genetic information in the genetic information database and the associations in the public or private database.

### CROSS REFERENCE TO RELATED APPLICATION

This application is a continuation-in-part of application Ser. No. 14/422,123, filed Feb. 17, 2015, which claims priority to International Application No. PCT/BR2013/000317, filed on Aug. 19, 2013, which claims priority to U.S. Provisional Application No. 61/684,632, filed on Aug. 17, 2012, which is hereby incorporated by reference in its entirety.

### FIELD OF THE DISCLOSURE

The present disclosure is generally related to e-commerce systems and methods, and more particularly is related to e-commerce systems and methods for providing offers of products or services to users based at least in part on the users' genetic information.

### BACKGROUND OF THE DISCLOSURE

In the digital age, consumers are increasingly turning to the Internet and electronic commerce (“e-commerce”) websites, to purchase the products and services they desire. Many e-commerce sites collect information about shoppers which can be used to more effectively target advertisements or offers to consumers, for example, based on zip code, age, gender, purchase history and so on. However, the offering and selling of products through e-commerce techniques are far from optimized. For example, a consumer may have a particular health condition or risk which would be exacerbated by the purchase and use of certain products, e.g., a dietary or drug product. Thus, directing advertisements or offers a user for such products is likely to be totally ineffective and may even present a health risk. A lactose-intolerant person, for example, is not likely to be particularly receptive to a directed advertisement or offer to purchase products containing lactose.

With the advent of low cost genetic sequencing through various companies, it is now possible to send a biologic sample to a sequencing company through the mail and receive a file containing complete genetic information for an individual. However, this information has thus far been used only within the realm of medicine and medical research, e.g., to determine whether the person carries a certain cancer risk, or risk of developing some other disease or condition.

With many associations between certain genetic information or other biomarkers and certain products (such as pharmaceuticals, nutraceuticals, foods, etc.) now known, and others rapidly becoming known, it is possible to customize or tailor products to a specific person based on their genetic information. However, existing e-commerce techniques are suited for optimizing and personalizing products based on such information.

Accordingly a need exists for e-commerce systems and methods for offering products or services to users based on the users' genetic information.

### SUMMARY OF THE DISCLOSURE

Embodiments of the present disclosure provide a genetic-based e-commerce system. Briefly described, in architecture, one embodiment of the system, among others, can be implemented as follows. A genetic-based e-commerce system includes a genetic-based e-commerce application server, a genetic information database and a genetic association database. The genetic information database is electronically accessible over at least one network system and stores genetic information associated with at least one user of the system. In a preferred embodiment, the genetic information database requires authentication for access for user information privacy or security. The genetic association database may be a public or private database electronically accessible over at least one network system. The genetic association database and stores associations between genetic information and products or services. In some embodiments, the associations are categorized to sort certain products or services generally not suitable for users with particular gene. The categorized associations may be further quantized for additional classification. The genetic-based e-commerce application server is electronically accessible over at least one network system to one or more user computer devices, and is configured to facilitate purchase by the user of products or services based on the user's genetic information in the genetic information database and the associations in the public or private database.

In another aspect, the present disclosure provides an e-commerce method for offering products or services to a user based on the user's genetic information that includes the steps of: receiving genetic information associated with the user, and storing the information in a genetic information database, electronically accessible over at least one network system; establishing association between the user's genetic information and products or services, said associations being stored in a genetic association database, electronically accessible over at least one network system; and facilitating, by a genetic-based e-commerce application hosted at least partially on a server and electronically accessible over at least one network system to a user computer device, purchase by the user of products or services based on the user's genetic information in the genetic information database and the associated products or services.

In yet another aspect, the genetic-based c-commerce system processes purchase by the user of products or services based on both the user's genetic information and user purchase history. Once an order for a product from a user is received, the genetic-based e-commerce application server verifies the user information, retrieves the user's genetic information from the genetic information database with user authorization and receives a list of products associated with the retrieved genetic information from the genetic association database. The product being ordered is then checked against the list of products. If the product being ordered belongs to the list of products, an alert is sent to the user for verification before the order is granted or processed. In some embodiments, the genetic-based e-commerce application server further checks purchase history of the user. If the product being ordered was ordered before, the order will be processed without sending an alert for further verification. If the product being ordered was not ordered before, an alert is sent to the user for verification and the order is processed after the user's verification is received.

In yet another aspect, the present disclosure provides a non-transitory computer readable medium containing instructions for providing an e-commerce method for offering products or services to a user based on the user's genetic information, enabled at least in part on a processor of a computerized device, wherein a genetic information database is electronically accessible by the processor, the genetic information database storing information associated with the user, and a genetic-based e-commerce application is hosted at least partially on a server and electronically accessible over at least one network system to a user computer device, the instructions, which when executed by the processor, performing the steps of: establishing associations between genetic information of the user with products or services, said associations being stored in a genetic association database, electronically accessible over at least one network system; and facilitating purchase by the user of products or services based on the user's genetic information in the genetic information database and the associations in the genetic association database.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic illustration a genetic-based e-commerce system, in accordance with a first exemplary embodiment of the present disclosure.

FIG. 2 is a flowchart illustrating a genetic-based e-commerce method, in accordance with an embodiment of the present disclosure.

FIG. 3 is a flowchart illustrating an exemplary e-commerce method for offering products or services to a user based on the user's genetic information.

FIG. 4 is a flowchart illustrating another exemplary e-commerce method for offering products or services to a user based on the user's genetic information.

FIG. 5 is a flowchart illustrating yet another e-commerce method for offering products or services to a user based on the user's genetic information and purchase history.

FIG. 6 is a simplified block diagram of the genetic-based e-commerce sever for the implementation of genetic-based e-commerce according to embodiments of the present disclosure.

### DETAILED DESCRIPTION

Many embodiments of the disclosure may take the form of computer-executable instructions, including algorithms executed by a programmable computer. However, the disclosure can be practiced with other computer system configurations as well. Certain aspects of the disclosure can be embodied in a special-purpose computer or data processor that is specifically programmed, configured or constructed to perform one or more of the computer-executable algorithms described below. Accordingly, the term “computer” as generally used herein refers to any data processor and includes Internet appliances, hand-held devices (including palm-top computers, wearable computers, cellular or mobile phones, multi-processor systems, processor-based or programmable consumer electronics, network computers, minicomputers) and the like.

The disclosure also can be practiced in distributed computing environments, where tasks or modules are performed by remote processing devices that are linked through a communications network. Moreover, the disclosure can be practiced in Internet-based or cloud computing environments, where shared resources, software and information may be provided to computers and other devices on demand. In a distributed computing environment, program modules or subroutines may be located in both local and remote memory storage devices. Aspects of the disclosure described below may be stored or distributed on computer-readable media, including magnetic and optically readable and removable computer disks, fixed magnetic disks, floppy disk drive, optical disk drive, magneto-optical disk drive, magnetic tape, hard-disk drive (HDD), solid state drive (SSD), compact flash or non-volatile memory, as well as distributed electronically over networks including the cloud. Data structures and transmissions of data particular to aspects of the disclosure are also encompassed within the scope of the disclosure.

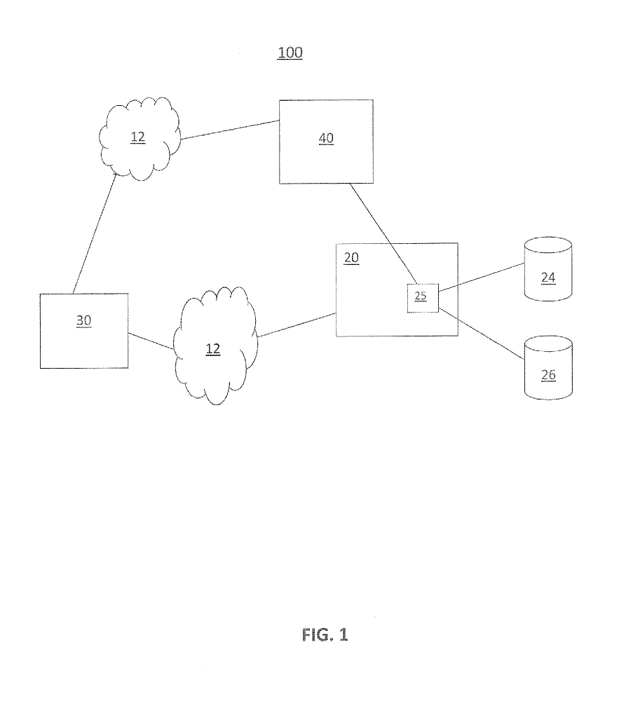

FIG. 1 is a schematic illustration of a genetic-based e-commerce system 10, in accordance with a first exemplary embodiment of the present disclosure. The genetic-based e-commerce system 10, which may also be referred to as ‘system 10’, includes a genetic-based e-commerce application 25 (‘application 25’), electronically accessible over at least one network system 12 and hosted at least partially on a genetic-based e-commerce application server 20. At least one user computer device 30 is positioned to access the application 25.

The genetic-based e-commerce application server 20 may be or include any database capable of storing and/or providing access to information, such as an electronic database, a computer and/or computerized server, database server or generally any network host capable of storing data and connected to any type of data network. Further, the genetic-based e-commerce application server 20 may include or be a part of a distributed network or cloud computing environment. Any type of electronic and/or computerized device that is capable of storing information may be included as the server 20, and is considered within the scope of this disclosure. The genetic-based e-commerce application server 20 may include computer-readable storage media, and a processor for processing data and executing algorithms, including any of the processes and algorithms set forth in this disclosure. The genetic-based e-commerce application 25 is electronically accessible over at least one network system 12. The network system 12 may include any type of network infrastructure, such as the Internet, or any other wired, wireless and/or partially wired network. The server 20, application 25 and network system 12 may include a variety of hardware and software components to provide successful functioning of the server 20 and the application 25, as is well-known within the art. Further, any features, characteristics, designs and/or functions that are known within the art may be included with the system 10 to further enhance its efficiency.

The user device 30 may be any computer device that is capable of communicating with the application 25, for example via a network system 12, and may be operated by any person using the system 10, or any representative thereof. Any number of user devices 30 may use the system 10 at any given time. The user device 30 may access the application 25 through a variety of ways, including through a computerized device in communication with the system 10 over a network system. For example, the user device 30 may be any computer, including any personal computer, Internet appliance, hand-held device (including palm-top computers, wearable computers, cellular or mobile phones, multi-processor systems, processor-based or programmable consumer electronics, network computers, minicomputers) and the like. One or more input devices, such as a keyboard or mouse, may be used to transmit information to and/or request information from the application 25 by the user device 30.

The genetic-based e-commerce application 25 may be fully or partially hosted on the server 20. The application 25 may include any tool, device, system, process or combination thereof, which receives genetic or other biologic information from a user and provides third-party e-commerce sites 40 access to the information based on proper authorization and acceptance of any relevant terms and/or conditions. The application 25 may include any computer-readable memory or databases, which may be stored in any computer-readable medium, and may be accessible by a computer processor. The application 25 may further include or access computer program instructions which may cause a processor to perform any algorithms and/or functions which may be described in this disclosure.

The system 10 further includes a genetic information database 24. The application 25 has access to the genetic information database 24, which may be fully or partially hosted on the server 20, or may be hosted elsewhere and otherwise accessible to the application 25. The genetic information database 24 stores genetic information associated with users of the system 10. The information genetic information associated with users may be stored in profiles. The information associated with users in the genetic information database 24 may further include, for example: contact information (e.g., name, address, phone number, etc.) for users, information relating to products and/or services purchased by the users through the system 10, dietary or other health-related information for the user (e.g., current medications, diet, health history, etc.), and/or any other information which may be relevant to users of the genetic-based e-commerce system 10.

Users' genetic information may be sequenced via a third party company. Once the user has possession of his genetic information, the user accesses the application 25 and creates an account, uploading the genetic information over an encrypted connection. This information contains a list of genetic biomarkers specific to that person, and can be presented in a wide variety of formats (the most common currently in use are 23andMe, deCODEme, Navigenics and FTDNA, but in future other formats may be used as they become more widespread). This genetic information is associated with the user and stored in the genetic information database 24.

Genetic association database(s) 26 may be included in the system 10 and may include information relating to associations between genetic or other biomarkers and products, such as pharmaceuticals, nutraceuticals, foods, dietary needs or other such products. The Genetic association database(s) 26 may be public or private. One example of a public database 26 which may be included in the system is the FDA's “Table of Pharmacogenomic Biomarkers in Drug Labels,” which contains information about the relation between certain medicines and biomarkers. The user genetic biomarker information, stored in genetic information database 24, is cross-indexed with information in the Genetic association database(s) 26.

As an example, the user's genetic information may indicate that the user will be affected differently by a standard dosage of a particular drug, vitamin or supplement than would most others. In such a case, the optimal dosage for the person may be determined, based on, for example, information stored in the Genetic association database(s) 26 that associate optimal dosages of the product with different genotypes or genetic information. The optimized dosage of the product may then be displayed to the user and offered for sale through the application 25, or communicated to third party sites 40 which may then offer the product for sale to the user.

The information in the public or private databases 26 may further include information relating to products and/or services which may reduce the risks of developing conditions for which the user's genetic information indicates that the user may be particularly at risk of developing. For example, a user having genetic information indicating a high risk of developing cardiovascular disease may be presented with suggested products and/or services which may help reduce that risk, such as certain drug products, nutraceuticals, supplements, diet plans, exercise equipment or programs, gym memberships, or any other products or services which may potentially reduce such a risk of cardiovascular disease.

Further, the application 25 may associate the genetic information of users with the products or services the users purchase through the application 25 (and/or through third party sites 40, with purchase history being transmitted from the third party sites 40 to the application 25). Based on these associations, the application 25 may determine that those having a particular genotype tend to purchase particular types of products. Targeted advertising and e-commerce based on user information such as zip code, age and gender may be known. However, genetic information may also be relevant regarding consumer behavior, and this information may be used to present the user with a variety of products and services which may be of particular interest to the user, as determined based on the user's genetic information.

In the case of health related products, certain drug-drug, drug-supplement and the like relationships are known or may become known. Thus, a user that has ordered one drug, supplement, vitamin, etc. (whether through a third party site 40 having access to the application 25, or directly through the application 25) may be presented with a complementary product or service which optimizes the efficacy of the first drug, supplement, vitamin, etc.

The application 25 (and/or third party sites 40 having access to the application 25) thus provides users with products and/or services which are uniquely optimized for the user, which may be suggested for the user as complementary or risk-reducing products and services and/or may be predicted to be of particular interest to the user based on the user's genetic information and the information stored in the Genetic association database(s) 26.

The application 25 may include or provide access to a web or network-based software platform, including a graphical user interface or webpage which provides interactive access to the system 10 to a user of a user device 30. The genetic-based e-commerce application 25 may be a web-based application and may require authorization information, such as username and password, before allowing the user to access the application 25.

Third party e-commerce sites 40 may be given access to the application 25, upon subscribing and subject to authorization, verification, and acceptance of terms and conditions as may be specified by the user and/or the company operating or responsible for the application 25. Upon subscribing, third party e-commerce sites 40 may specify a selection of pertinent biomarkers (e.g., biomarkers which the third party e-commerce site 40 deems relevant to particular products or services that it offers) and when a user logs into an account (or is otherwise identified upon accessing the third party site 40) at the e-commerce site 40, the application 25 (i.e., the genetic information database 24 and/or the genetic association database(s) 26) is queried as to the presence of certain genetic biomarkers being associated with the user. The third party e-commerce site 40 can then present products and services tailored to this genetic information and thus personalized for the user based on the user's genetic information. The third party e-commerce site 40 can present the products and services as a list of ready-made products (e.g., a dietary supplement known to be effective for treating a condition or risk-factor associated with a particular biomarker) or custom-manufactured products tailored to the individual (e.g., pharmaceutical products tailored for the user based on the user's genetic biomarkers).

Alternatively or additionally, third party e-commerce sites 40 may submit a list of products to the application 25, organized by type of product, and a list of biomarkers that would be compatible with the products. This information may be stored in a database and accessible to the application 25. For example, the information submitted by the third party e-commerce sites 40 may include associations between products and genetic information or biomarkers and this information may be stored in the genetic association database(s) 26. The customer may thus access the application 25 with a user device 30, select the type of product he has interest in, and will see a list of products that are recommended by the application 25 based on his genetic biomarkers.

### Example

The following is an example which illustrates use of the system 10, in accordance with an embodiment of the present disclosure.

“John Doe” has an account through the application 25 (which may be, for example, an online service called “Genomnics”). John Doe uploads his genetic information, where it is stored and indexed in the genetic information database 24. John Doe then visits a food and grocery online store (e.g., a third party site 40 called “Must Eat Foods”) that is a subscriber to Genomnics' services and creates an online account there, informing the online grocery store of his Genomnics account number (or other identifying information) during signup.

“Must Eat Foods”, when it subscribed to Genomnics, decided it would like to check for lactose intolerance (which research indicates as being detected in the 2q21 locus). When “John Doe” logs onto “Must Eat Foods” they, behind-the-scenes, access Genomnics information, which sends them the response that account XYZ is lactose intolerant. With this information on hand, “Must Eat Foods” presents products that are safe for “John Doe” to consume, and displays a warning on products that could be harmful to him.

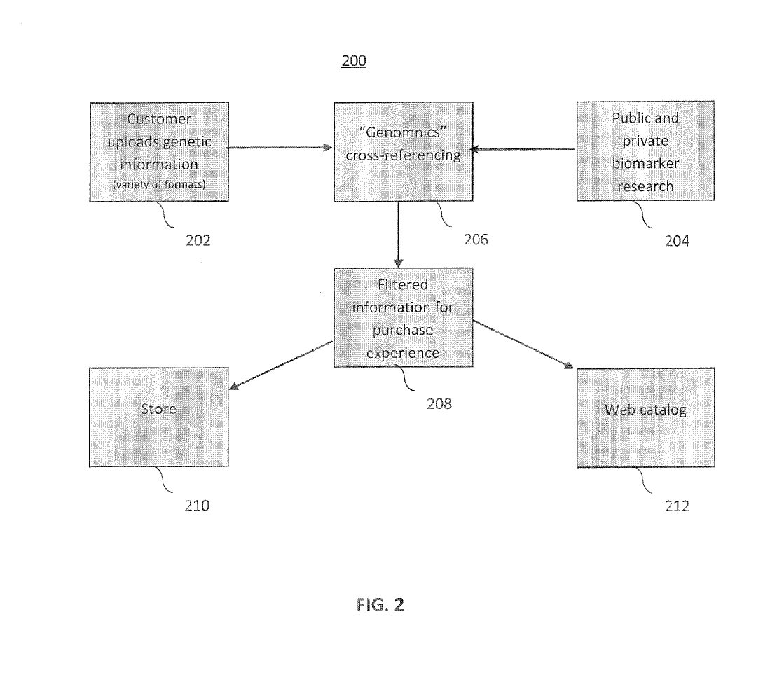

FIG. 2 is a flowchart 200 illustrating a genetic-based e-commerce method, in accordance with an embodiment of the disclosure. It should be noted that any process descriptions or blocks in flow charts should be understood as representing modules, segments, portions of code, or steps that include one or more instructions for implementing specific logical functions in the process, and alternate implementations are included within the scope of the present invention in which functions may be executed out of order from that shown or discussed, including substantially concurrently in reverse order, depending on the functionality involved, as would be understood by those reasonably skilled in the art of the present invention.

At block 202, a user uploads his genetic information to the application 25, e.g., by using user device 30 to access a website provided by the application 25 and uploading genetic information which may have been provided by a third party service. At block 204, the application 25 accesses public and private biomarker research which correlates biomarker or other genetic information with medicines, pharmaceuticals, nutraceuticals, foods, or other products or services (this information may be stored in the public or private database 26). At block 206, the application 25 cross-references the user's genetic information with the information in the public or private database 26, and at block 208 filters the information for purchase experience. That is, the application 25 may determine relevant products or services which are particularly suited for the user, based on the user's genetic information and the information in the public or private database 26. At block 210, third party e-commerce sites 40 access the user's genetic information, and/or information relating to products or services suited to that user, through the application 25, thus enabling the sites 40 to offer products personalized for the user based on the user's genetic information. At block 212, a web catalog may be produced. The web catalog may be produced based on products or services offered by subscribing third party c-commerce sites 40, with the products or services associated with particular biomarkers. The application 25 may thus access the products or services in the web catalog, enabling a user to purchase those products or services particularly suited to him through the application 25.

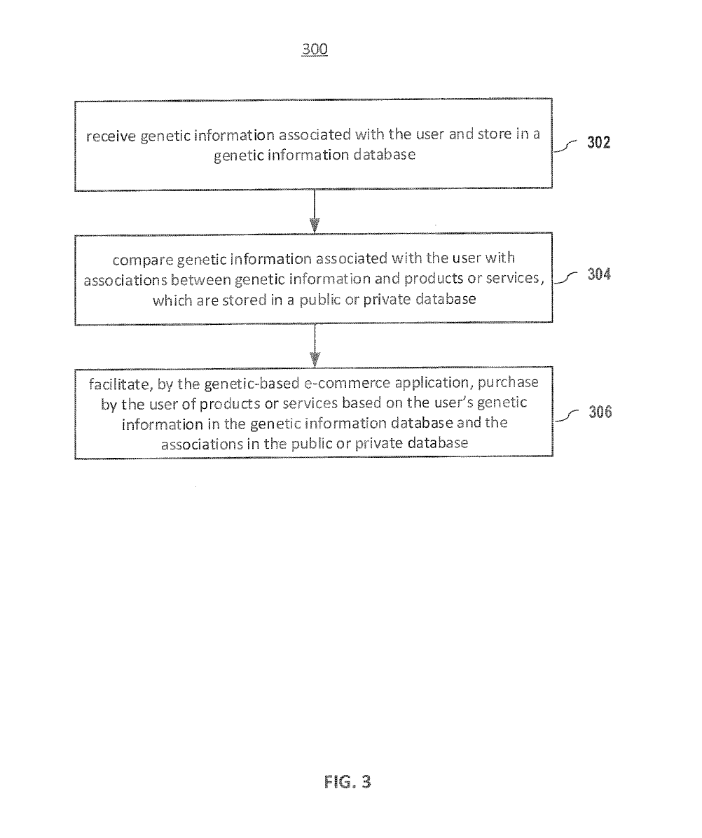

FIG. 3 is a flowchart 300 illustrating an exemplary e-commerce method for offering products or services to a user based on the user's genetic information, in accordance with an embodiment of the disclosure.

As shown in block 302, genetic information associated with the user is received and stored in a genetic information database 24, electronically accessible over at least one network system. At block 304, the genetic information associated with the user is compared with associations between genetic information and products or services, which are stored in a public or private database 26. At block 306, a genetic-based e-commerce application 25, hosted at least partially on a server and electronically accessible over at least one network system to a user computer device, facilitates purchase by the user of products or services based on the user's genetic information in the genetic information database 24 and the associations in the public or private database 26.

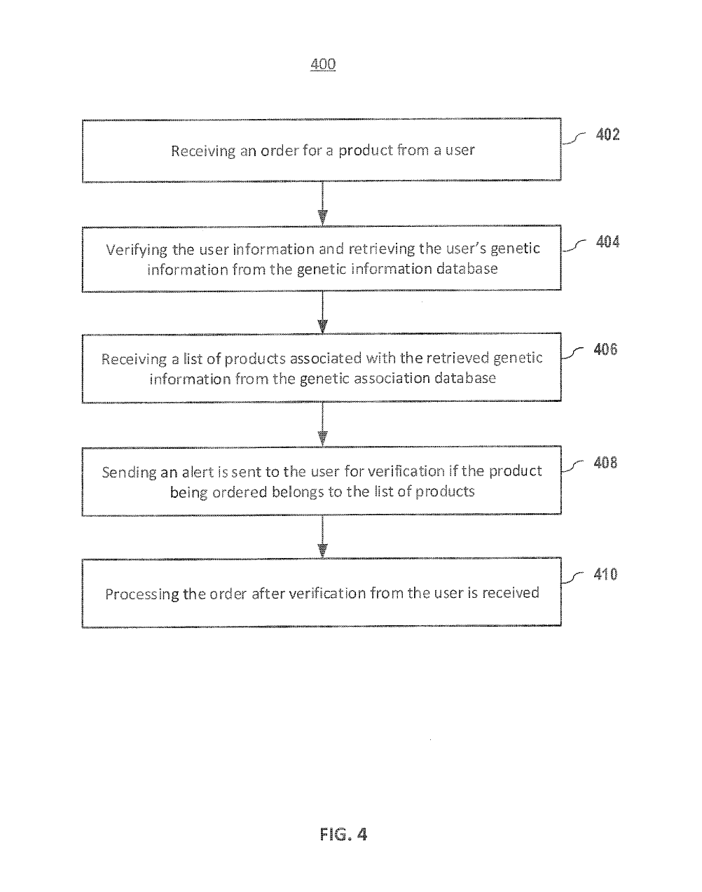

FIG. 4 is a flowchart illustrating another exemplary e-commerce method for offering products or services to a user based on the user's genetic information. As shown in step 402, an order for a product from a user is received at the genetic-based e-commerce application server. At step 404, the server verifies the user information and retrieves the user's genetic information from the genetic information database with user authorization. The user authorization may be preset when the user registered at the e-commerce application server. At step 406, the genetic-based e-commerce application server receives a list of products associated with the retrieved genetic information from the genetic association database. At step 408, the product being ordered is checked against the list of products. If the product being ordered belongs to the list of products, an alert is sent to the user for verification. At step 410, the order is granted or processed after verification from the user is received.

In some embodiments, the associations between genetic information and products are configured to sort out products or services generally not suitable for a particular gene. The associations may be further categorized for additional classification according to the severeness of consequence if those associated products being taken by the user. If the product being ordered is categorized as high severeness, the order may be rejected or processed only after user confirmation is received in response to the alert. If the product being ordered is categorized as mild severeness, the order may be processed with a warning notice and without requiring user's further confirmation.

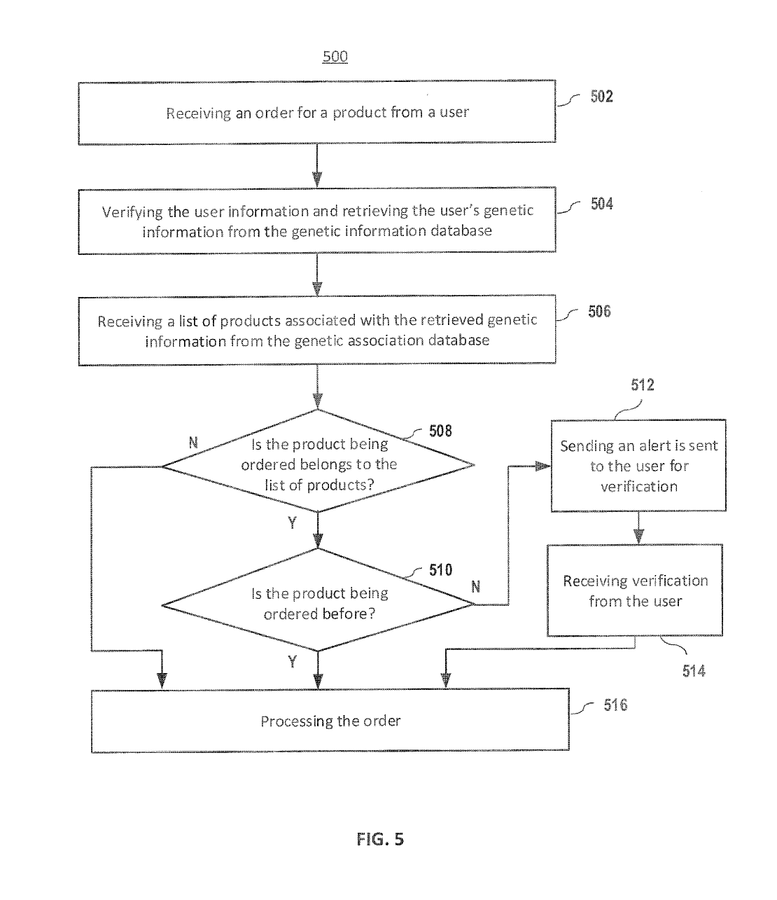

FIG. 5 is a flowchart illustrating yet another e-commerce method for offering products or services to a user based on the user's genetic information and purchase history. Steps 502˜506 are similar to steps 402˜406 described above. As shown in step 508, an order for a product from a user is received at the genetic-based e-commerce application server. At step 508, the product being ordered is check to verify whether it is belong to the list of products associated with the user's retrieved genetic information. If no, the process goes to step 516 where the order for the product is processed. If yes, the process goes to step 510 where the product being ordered is check whether the product being ordered before by accessing a purchase history record of the user. The purchase history record may be stored within the genetic-based e-commerce application server or a different location accessible to the server. If yes, the process goes to step 516 where the order for the product is processed. If no, the process goes to step 512 where an alert is sent to the user for verification. After the verification from the user is received at step 514, the order is granted or processed at step 516.

Although exemplary steps for exemplary genetic-based e-commerce implementations are shown in FIGS. 3-5, it shall be noted that these steps are performed under specific conditions using a specific embodiment or embodiments; accordingly, neither these steps shall be used to limit the scope of the disclosure of the current patent document. Furthermore, it shall be noted that certain steps may be performed optionally or performed in different orders as disclosed and certain steps may be done concurrently.

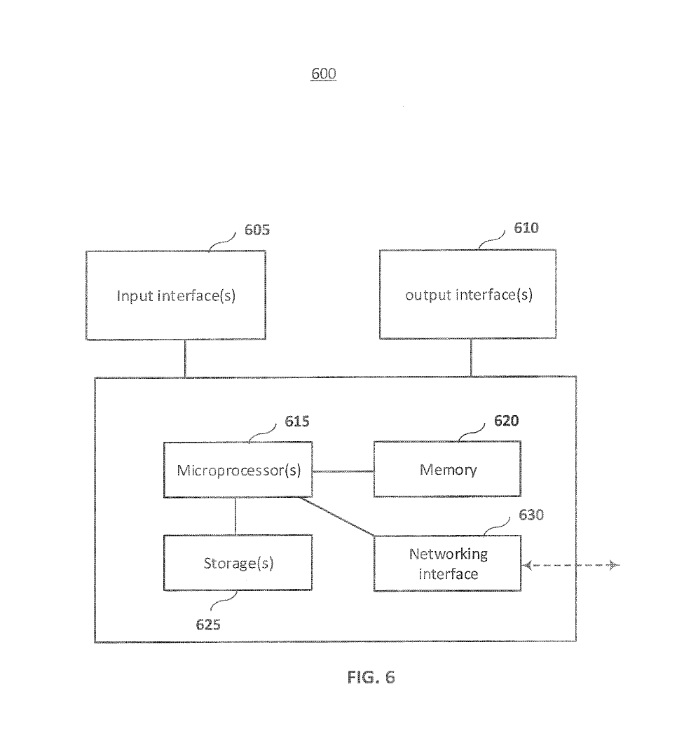

FIG. 6 is a block diagram of a genetic-based e-commerce sever for the implementation of genetic-based e-commerce according to embodiments of the present disclosure. It will be understood that the functionalities shown for server 600 may operate to support various embodiments of a computing system although it shall be understood that a server may be differently configured and include different components. As illustrated in FIG. 6, the server 600 includes one or more microprocessors 615 that provides computing resources and controls the server. Server 600 may also include a system memory 620, which may be in the form of random-access memory (RAM), read-only memory (ROM), or both. Server 600 may also include an interface 605 to receiving inputs from various input devices and an output interface 610 to output information to various output devices, such as a display and/or a speaker, etc.

It should be understood that various system components may or may not be in physical proximity to one another. For example, image/question input and answer output may be remotely transmitted from one physical location to another. In addition, programs that implement various aspects of this invention may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A genetic-based e-commerce system comprising:
a genetic information database storing genetic information associated with at least one user of the system;
a genetic association database storing associations between genetic information and products; and
a genetic-based e-commerce application server coupled to the genetic information database and the genetic association database, the e-commerce application server electronically accessible over at least one network system to a user computer device;
wherein the genetic-based e-commerce application server receives an order for a product from a user, retrieves the user's genetic information from the genetic information database, receives a list of products associated with the retrieved genetic information from the genetic association database, and processes the order based at least on the product and the received list of products.

2. The system of claim 1, wherein the genetic-based e-commerce application server is accessible to a third party e-commerce website, and the third party e-commerce website offers the user products or services based on the user's genetic information in the genetic information database and the associations in the public or private database.

3. The system of claim 1, wherein the genetic-based e-commerce application server is configured to receive information from a third party e-commerce website relating to products or services offered by the third party e-commerce website and associations between those products or services and particular genetic information, and the genetic-based e-commerce application provides the user with access to purchase relevant products or services, based on the user's genetic information.

4. The system of claim 1, wherein the genetic information database includes information relating to at least one of: contact information for the user, information relating to products and/or services purchased by the user through the system, and dietary or other health-related information for the user.

5. The system of claim 2, wherein the products or services based on the user's genetic information in the genetic information database and the associations in the public or private database include custom-manufactured products made specifically for the user.

6. The system of claim 1, wherein the products or services comprise pharmaceutical or food products.

7. The system of claim 1, wherein the genetic-based e-commerce application server process the order further based on a purchase history record of the user.

8. An e-commerce method for offering products or services to a user based on the user's genetic information, comprising:
receiving an order for a product from a user at the genetic-based e-commerce application server;
retrieving the user's genetic information from a genetic information database with user authorization;
receiving, at the genetic-based e-commerce application server, a list of products associated with the retrieved genetic information from a genetic association database;
checking the product being ordered against the list of products and sending an alert to the user for verification based at least on checking result; and
processing the order after receiving verification from the user.

9. The method of claim 8, further comprising:
providing a third party e-commerce website with access to the genetic-based e-commerce application, such that the third party e-commerce website can offer the user products or services based on the user's genetic information in the genetic information database and the associations in the public or private database.

10. The method of claim 8, further comprising:
receiving, by the genetic-based e-commerce application server, information from a third party e-commerce website relating to products or services offered by the third party e-commerce website and associations between those products or services and particular genetic information; and
providing, by the genetic-based e-commerce application server, the user with access to purchase relevant products or services, based on the user's genetic information and the information received from the third party e-commerce website.

11. The method of claim 8, wherein the genetic information database includes information relating to at least one of: contact information for the user, information relating to products and/or services purchased by the user through the system, and dietary or other health-related information for the user.

12. The method of claim 8 further comprising the steps of checking the product being ordered against a purchase history record and processing the order if the product being ordered before.

13. The method of claim 8 further comprising the steps of checking the product being ordered against a purchase history record and sending the alert to the user for verification if the product being ordered belongs to the list and the product is not ordered before.

14. The method of claim 12, wherein the purchase history record is stored within the genetic-based e-commerce application server.

15. A non-transitory computer readable medium containing instructions for providing an e-commerce method for processing product orders from a user based on the user's genetic information, enabled at least in part on a processor of a genetic-based e-commerce application device, when executed by the processor, performing the steps of:
receiving an order for a product from a user;
retrieving the user's genetic information from a genetic information database electronically accessible by the processor;
receiving a list of products associated with the retrieved genetic information from a genetic association database electronically accessible by the processor;
checking the product being ordered against the list of products and sending an alert to the user for verification based at least on checking result; and
processing the order after receiving verification from the user.

16. The non-transitory computer readable medium of claim 15, wherein the instructions, which when executed by the processor, further perform the step of:
providing a third party e-commerce website with access to the genetic-based e-commerce application, such that the third party e-commerce website can offer the user products or services based on the user's genetic information in the genetic information database and the associations in the public or private database.

17. The non-transitory computer readable medium of claim 15, wherein the instructions, which when executed by the processor, further perform the steps of:
receiving, by the genetic-based e-commerce application server, information from a third party e-commerce website relating to products or services offered by the third party e-commerce website and associations between those products or services and particular genetic information; and
providing, by the genetic-based e-commerce application, the user with access to purchase relevant products or services, based on the user's genetic information and the information received from the third party e-commerce website.

18. The non-transitory computer readable medium of claim 15, wherein the instructions, which when executed by the processor, further perform the step of:
checking the product being ordered against a purchase history record and processing the order if the product being ordered before.

19. The non-transitory computer readable medium of claim 15, wherein the instructions, which when executed by the processor, further perform the step of:
checking the product being ordered against a purchase history record and sending the alert to the user for verification if the product being ordered belongs to the list and the product is not ordered before.

20. The non-transitory computer readable medium of claim 18, wherein the purchase history record is stored within the genetic-based e-commerce application device.
